(19) United States
(12) Patent Application Publication
(10) Pub. No.: US 2025/0159560 A1
(43) Pub. Date: May 15, 2025

(54) INTER RADIO ACCESS TECHNOLOGY TRANSITIONS AND MILLIMETER WAVE ADDITION

(71) Applicant: T-Mobile Innovations LLC, Overland Park, KS (US)

(72) Inventors: Christopher Thomas BAILEY, Overland Park, KS (US); Ryan Patrick DREILING, Shawnee, KS (US); Kavitha SWAMINATHAN, Olathe, KS (US)

(21) Appl. No.: 18/389,326

(22) Filed: Nov. 14, 2023

(51) Int. Cl. H04W 36/00; H04W 36/08; H04W 36/30

(52) U.S. Cl. CPC H04W 36/0058; H04W 36/0069; H04W 36/08; H04W 36/302

(57) ABSTRACT

Systems, methods and devices are provided for providing millimeter wave coverage for capable devices connected to standalone networks. Methods include receiving a capability report and a measurement report from a wireless device and determining based on the capability report that the wireless device supports millimeter wave (mmWave) coverage, but does not support new radio dual connectivity (NRDC). Methods provided herein further include determining, based on the measurement report, that the wireless device is in a location having a threshold strength of mmWave coverage; and transitioning the wireless device to another access node to allow for the mm Wave coverage.

### TECHNICAL BACKGROUND

A wireless network, such as a cellular network, can include an access node (e.g., base station) serving multiple wireless devices or user equipment (UE) in a geographical area covered by a radio frequency transmission provided by the access node. Access nodes may deploy different carriers within the cellular network utilizing different types of radio access technologies (RATs). RATs can include, for example, 3G RATs (e.g., GSM, CDMA etc.), 4G RATs (e.g., WiMax, LTE, etc.), and 5G RATs (new radio (NR)) and 6G RATs.

Further, different types of access nodes may be implemented for deployment for the various RATs. For example, an evolved NodeB (eNodeB or eNB) may be utilized for 4G RATs and a next generation NodeB (gNodeB or gNB) may be utilized for 5G RATs. Further, gNBs may be used for 5G millimeter wave (mmWave) deployments, which provide larger contiguous bandwidths and higher frequencies than other 5G transmissions. Deployment of the evolving RATs in a network provides numerous benefits. For example, newer RATs may provide additional resources to subscribers, faster communications speeds, and other advantages. For example, 5G standalone (SA) networks provide the capability for lower latency and higher speeds.

With the introduction of 5GSA networks, network operators often aim to push wireless devices to connect to the 5GSA networks because of their advantages. However, in some instances, services available on the more mature 5G non-standalone (NSA) network may not be available to the wireless devices on the 5GSA networks. Further, because 4G or LTE is a more mature RAT than 5G, it thus provides additional services not always available in a 5GSA network. Additionally, wireless devices may not yet have capabilities to utilize all services available in 5GSA.

Hence, a need exists for ensuring wireless devices utilizing a newer, less mature 5GSA network are able to utilize more fully developed services that might be unavailable to the wireless device in the 5GSA network, but remain available to the wireless device in the 5GNSA network. Lack of availability of services may be due to the less mature 5GSA network or alternatively to the lack of capabilities of the wireless device. For example, many wireless device do not have the capability to utilize mmWave transmissions a 5GSA network.

### Overview

Exemplary embodiments described herein include systems, methods, and processing nodes for ensuring availability of mmWave to wireless devices in a location having a threshold strength mmWave signal regardless of the currently connected core network. Accordingly, wireless devices connected to a 5GSA network may not be capable of connecting to mm Wave while connected to the 5GSA network. However, if the wireless device is within range of mm Wave transmissions, the wireless device can be reassigned to the 5GNSA network to receive the mmWave transmissions.

A method includes receiving a capability report and a measurement report from a wireless device. The method additionally includes determining based on the capability report that the wireless device supports millimeter wave (mmWave) coverage, but does not support new radio dual connectivity (NRDC). The method further includes determining, based on the measurement report, that the wireless device is in a location having a threshold strength of mm Wave coverage and transitioning the wireless device to another access node to allow for the mmWave coverage.

In embodiments provided herein, transitioning the wireless device to another access node includes handing the wireless device over to a long term evolution (LTE) eNodeB in a 5G non-standalone cell. In embodiments provided herein, LTE is thereby provided as a main cell group (MCG) and mmWave as a secondary cell group (SCG) for the wireless device.

In further embodiments, a system for transitioning a wireless device to mmWave coverage includes a communication interface receiving a capability report and a measurement report from a wireless device. The system further includes a processor accessing stored instructions to perform multiple operations. The operations include determining, based on the capability report, that the wireless device supports millimeter wave (mmWave), but does not support new radio dual connectivity (NRDC). The operations further include determining, based on the measurement report, that the wireless device is in a location having threshold strong mm Wave coverage and transitioning the wireless device to another access node to allow for mmWave coverage based on the determinations.

In a further aspect, a non-transitory computer-readable medium is provided that stores instructions executed by a processor to perform multiple operations. The operations include receiving a capability report from a wireless device indicating that the wireless device supports millimeter wave (mmWave), but does not support new radio dual connectivity (NRDC). The operations further include receiving a measurement report from the wireless device and accessing stored threshold criteria for indicating the wireless device should receive mm Wave coverage. Additionally, the operations include comparing the measurement report with the stored threshold criteria to determine that the measurement report meets the stored threshold criteria. Further, the operations include assigning the wireless device to a 5G non-standalone cell capable of assigning mmWave coverage to the wireless device.

In embodiments provided herein, the measurement report includes channel state information reference signal (CSI-RS) feedback reporting precoding matrix indicator (PMI) values and the operations include comparing the received PMI values to stored information correlating PMI values with mmWave coverage.

### BRIEF DESCRIPTION OF THE DRAWINGS

FIG. 1 depicts an exemplary operating environment system for employing a mmWave assignment system in accordance with the disclosed embodiments.

FIG. 2 illustrates an additional exemplary operating environment for a mmWave assignment system in accordance with disclosed embodiments.

FIG. 3 illustrates an exemplary configuration for a mmWave assignment system in accordance with disclosed embodiments.

FIG. 4 depicts an exemplary access node in accordance with disclosed embodiments.

FIG. 5 depicts an exemplary method for mmWave assignment in accordance with the disclosed embodiments.

FIG. 6 depicts a further exemplary method for mmWave assignment in accordance with disclosed embodiments.

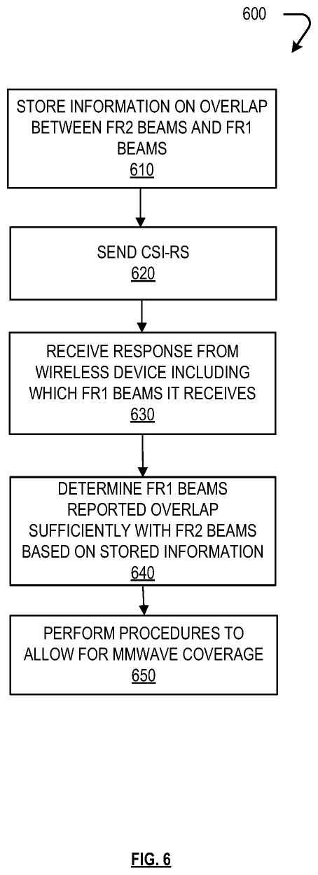

FIG. 7 depicts a further exemplary method for mmWave assignment in accordance with disclosed embodiments.

### DETAILED DESCRIPTION

Exemplary embodiments described herein include systems and methods for millimeter wave (mmWave) assignment in order to improve wireless device and network performance. Systems and methods described herein improve network performance, for example by contributing to efficient capacity management by transferring wireless devices from 5GSA in order to utilize the benefits of mmWave in an evolved-universal terrestrial radio access-new radio dual connectivity (EN-DC) network having little used mmWave capacity. The transferred wireless devices benefit from the larger bandwidth and higher frequencies offered with mmWave transmissions.

5G mm Wave coverage refers to higher frequencies starting, for example, at 24 GHz and above. While the coverage area for mm Wave transmissions is small, mm Wave bands offer extremely high bandwidth and high speeds. This range is referred to as high band 5G and is best used in densely populated areas across shorter ranges. This is in contrast to low band 5G signals that are designed for long-distance communication. These ranges may be used simultaneously in a network.

Given their characteristics, 5G mmWave transmissions are often deployed in crowded locations, such as sports arenas, stadiums, airports, concerts, busy shopping streets and other large venues. The mmWave bands offer a large increase in contiguous bandwidth compared with other 5G bands. As a result, mmWave deployments can handle a greater number of connections, while also boosting the peak data rates for individual devices.

With the emergence of 5GSA, network operators attempt to push capable wireless devices to 5GSA so that the wireless devices will receive the lower latency and higher data rates offered by 5GSA. While 5GSA networks may offer a service called new radio dual connectivity (NRDC), which may offer dual connection with more traditional 5G bands and 5G mmWave, many wireless devices are not yet capable of utilizing mm Wave with NRDC. Further, NRDC with mmWave transmission may not be available at all.

Many of these wireless devices utilizing 5GSA may also be located in crowded areas that may receive a superior benefit from using 5G mmWave, but are unable to utilize it. Further, because so many wireless devices having 5G mmWave capabilities in an ENDC 5GNSA environment are pushed to 5GSA, the mmWave capability of the 5GNSA network offering ENDC is under-utilized.

Accordingly, embodiments provided herein evaluate wireless devices connected to 5GSA for transition to 5G mmWave in ENDC. More specifically, embodiments provided herein evaluate wireless device capabilities prior to taking further steps to transition the wireless devices to ENDC. Methods provided herein, in response to a UE capability report, determine whether a wireless device connected to 5GSA is capable of using mmWave in NRDC. When wireless devices are connected to 5GSA, but are not capable of connecting to mmWave in NRDC, methods and systems provided herein take further steps to determine if the wireless device can utilize an interRAT (IRAT) transition to connect to mmWave in 5GNSA using ENDC.

Generally speaking, wireless devices may be slow to evolve to be able to leverage newer RATs. For example, while most existing wireless devices are 4G capable, a smaller percentage of wireless devices are 5G capable. Of those wireless devices that are 5G capable, most are backwards compatible so that they may be subject to transitions between 4G and 5G RATs. With the evolution of 5G standalone (SA), in which the core network has a 5G service-based architecture (SBA), wireless devices transitioning between 4G and 5G RATs are transitioning between different core networks.

Network operators strive to have devices utilize the newer RAT, e.g., 5G NRSA, which has increased benefits of larger bandwidths, increased speed, and network slicing. However, when devices are not capable of using all of the features of the newer 5GSA RAT, such as NRDC, they can transition back to 4GLTE and further utilize dual connectivity with 5GmmWave. The transition can be desirable due to the innate incapability of the device, or the lack of a particular service on the 5G NSA RAT.

Accordingly, systems, methods, and devices are proposed to determine whether a wireless device connected to a 5GSA network is located in an area of mmWave coverage. This can be done through taking measurement reports from the wireless device and comparing the contents of the measurement reports to stored information to determine whether the wireless device is located in an area having a threshold strong mm Wave signal. When the device is in an area having the threshold strong mmWave signal, embodiments provided herein may trigger a transition of the wireless device to 4G LTE. The connected eNB is then able to assign the wireless device to mmWave as a secondary cell group (SCG).

In embodiments described herein, processing tasks may be performed at cellular base stations or other edge nodes. Through the use of systems, methods, and devices described herein, a flexible assignment policy may be implemented based on wireless device capabilities and locations.

In addition to the systems and methods described herein, the operations for 5G mmWave assignment may be implemented as computer-readable instructions or methods, and processing nodes on the network for executing the instructions or methods. The processing node may include a processor included in the access node or a processor included in any controller node in the wireless network that is coupled to the access node.

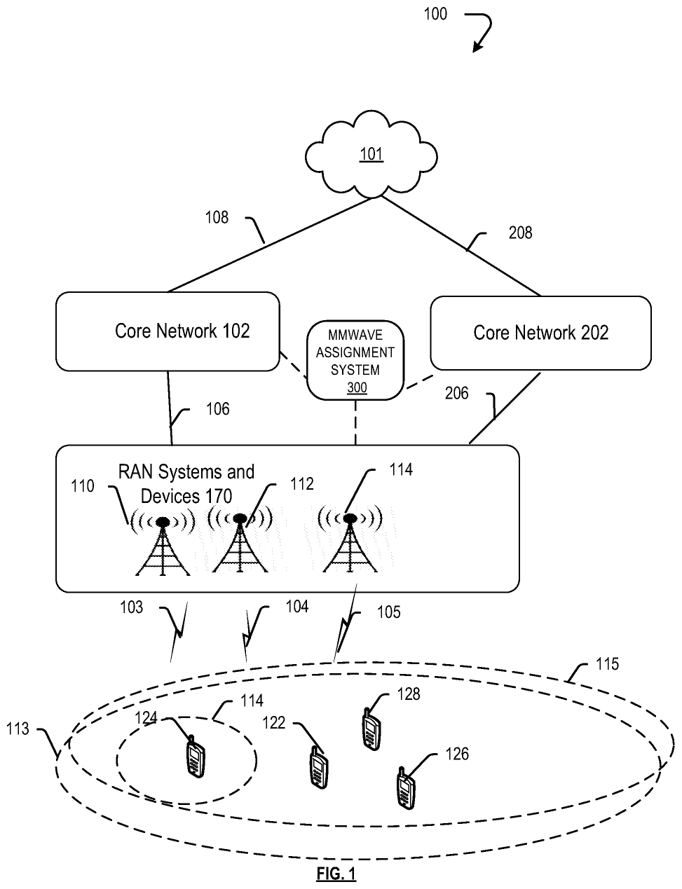

FIG. 1 depicts an exemplary environment 100 for wireless communications, in accordance with the disclosed embodiments. The environment 100 may include a communication network 101, multiple core networks 102 and 202 and radio access networks (RANs) 170, including multiple access nodes 110, 112, and 114. The core network 102 may be or include a 5GSA core network having a service based architecture (SBA). The core network 202 may be or include a 5GNSA core including an evolved packet core (EPC). Both the core 102 and the core 202 may connect to multiple access nodes. For example, the 5GSA core 102 may connect to a gNodeB 110 and a mmWave GnodeB 112. The 5GNSA core 202 may connect to the mmWave GnodeB 112 and an eNodeB 114.

The core networks 102 and 202 may be connected to the communication network 101 over communication links 108 and 208. The RAN 170 may include other devices and additional access nodes. The environment 100 also includes multiple wireless devices 122, 124, 126, and 128, which may be end-user wireless devices and may operate within one or more coverage areas 113, 114, 115 and communicate with the access nodes 110, 112, and 114 of the RAN 170 over the communication links 103, 104, and 105. In embodiments provided herein, the link 103 is a 5GNR communication link having a coverage area 113, the link 104 is 5G mmWave communication link having a coverage area 114, and the link 105 is a 4G LTE communication link serving coverage area 115.

The environment 100 may further include mmWave assignment system 300, which is illustrated as operating between the core networks 102 and 202 and the RAN 170. However, it should be noted that the mm Wave assignment system 300 may be distributed. For example, the mmWave assignment system 300 may utilize components located at both the core networks 102 and 202, at multiple access nodes 110, 112, 114 and at the wireless devices 122, 124, 126, 128. Alternatively, the mmWave assignment system 300 may be an entirely discrete component operating between the core networks 102, 202 and the RAN 170. In embodiments provided herein, the mmWave assignment system 300 is incorporated in the 5GSA access node 110.

The mmWave assignment system 300 receives information pertaining to wireless device capabilities and wireless device performance parameters from the wireless devices 122, 124, 126, and 128 in capability reports and measurement reports. The mmWave assignment system 300 analyzes this information to determine whether the wireless device should undergo an IRAT transition for assignment to mm Wave coverage.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices 122, 124, 126, 128. Wireless network protocols can comprise MBMS, code division multiple access (CDMA) 1×RTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

The core networks 102 and 202 include core network functions and elements. One core network, e.g. 202, may have an evolved packet core (EPC) structure and the other core network, e.g. 102 may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 101, and performs operations such as packet routing and forwarding, packet inspection, policy enforcement for the user plane, quality of service (QOS) handling, etc. The control plane functions may include, for example, a network slice selection function (NSSF), a network exposure function (NEF), a network repository function (NRF), a policy control function (PCF), a unified data management (UDM) function, an application function (AF), an access and mobility function (AMF), an authentication server function (AUSF), and a session management function (SMF). Additional or fewer control plane functions may also be included. The AMF receives connection and session related information from the wireless devices 122, 124, 126, 128 and is responsible for handling connection and mobility management tasks. The SMF is primarily responsible for creating, updating, and removing sessions and managing session context. The UDM function provides services to other core functions, such as the AMF, SMF, and NEF. The UDM may function as a stateful message store, holding information in local memory. The NSSF can be used by the AMF to assist with the selection of network slice instances that will serve a particular device. Further, the NEF provides a mechanism for securely exposing services and features of the core network.

Although two core networks 102 and 102 are shown, a single core network may be utilized that includes a distributed, cloud-native, converged core gateway instead of two distinct core networks. For example, the core networks 102 and 202 may be combined into a cloud native converged core network including both 5GSA and 4G. Thus, the converged core gateway could connect a 4G LTE evolved packet core (EPC) to a 5G core network.

Communication links 106, 206, 108, and 208 can use various communication media, such as air, space, metal, optical fiber, or some other signal propagation path, including combinations thereof. Communication links 106, 206 and 108, 208 can be wired or wireless and use various communication protocols such as Internet, Internet protocol (IP), local-area network (LAN), S1, optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, or combinations thereof. Other wireless protocols can also be used. Communication links 106, 206, 108, 208 can be direct links or might include various equipment, intermediate components, systems, and networks, such as a cell site router, etc. Communication links 106, 206, 108, and 208 may comprise many different signals sharing the same link.

The RAN 170 may include various access network systems and devices such as access nodes 110, 112, and 114. The RAN 170 is disposed between the core networks 102 and 202 and the end-user wireless devices 122, 124, 126, 128. Components of the RAN 170 may communicate directly with the core networks 102 and 202 and others may communicate directly with the end user wireless devices 122, 124, 126, 128. The RAN 170 may provide services from the core networks 102 and 202 to the end-user wireless devices 122, 124, 126, and 128.

The RAN 170 includes multiple access nodes (or base stations) 110, 112, 114. As set forth above, the access nodes or base stations may include a gNodeB 110, a mmWaveGnodeB 112, and an eNodeB 114. Additional access nodes or base stations may be included in the RAN 170. It is understood that the disclosed technology may also be applied to communication between an end-user wireless device and other network resources, such as relay nodes, controller nodes, antennas, etc. Further, multiple access nodes may be utilized. For example, some wireless devices may communicate with an LTE eNodeB and others may communicate with an NR gNodeB. Further, although one RAN 170 is shown, additional RANs may be utilized.

Access nodes 110, 112, 114 can be, for example, standard access nodes such as a macro-cell access node, a base transceiver station, a radio base station, an eNodeB device, an enhanced eNodeB device, a gNodeB in 5G New Radio (“5G NR”), or the like. The gNBs may include, for example, centralized units (CUs) and distributed units (DUs).

In additional embodiments, access nodes may comprise two co-located cells, or antenna/transceiver combinations that are mounted on the same structure. Alternatively, access nodes 110, 112, 114 may comprise a short range, low power, small-cell access node such as a microcell access node, a picocell access node, a femtocell access node, or a home eNodeB device. As will be further described below, functionality for mmWave assignment may be included within the access nodes. Access nodes 110, 112, 114 can be configured to deploy one or more different carriers, utilizing one or more RATs. For example, a gNodeB may support NR low-band, mid-band, or mmWave transmissions and an eNodeB may provide LTE coverage. Any other combination of access nodes and carriers deployed therefrom may be evident to those having ordinary skill in the art in light of this disclosure.

The access nodes 110, 112, 114 can comprise a processor and associated circuitry to execute or direct the execution of computer-readable instructions to perform operations such as those further described herein. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Further, in embodiments set forth herein, at least one access node, for example 110, is able to interact with the mm Wave assignment system 300 to assign specific wireless devices to enable mmWave communication.

The wireless devices 122, 124, 126, and 128 may include any wireless device included in a wireless network. For example, the term “wireless device” may include a relay node, which may communicate with an access node. The term “wireless device” may also include an end-user wireless device, which may communicate with the access node in the access network 170 through the relay node. The term “wireless device” may further include an end-user wireless device that communicates with the access node directly without being relayed by a relay node. In embodiments disclosed herein, the wireless devices 122, 124, 126, and 128 may be equipped with particular processing components to report relevant information to the mmWave assignment system 300, such as device location, device route, device speed, device type, and performance parameters. Further, the wireless devices may be equipped with logic to respond to instructions generated by the mmWave assignment system 300.

Wireless devices 122, 124, 126, and 128 may be any device, system, combination of devices, or other such communication platform capable of communicating wirelessly with access network 170 using one or more frequency bands and wireless carriers deployed therefrom. Each of wireless devices 122, 124, 126, and 128, may be, for example, a mobile phone, a wireless phone, a wireless modem, a personal digital assistant (PDA), a voice over internet protocol (VOIP) phone, a voice over packet (VOP) phone, or a soft phone, an internet of things (IoT) device, as well as other types of devices or systems that can send and receive audio or data. The wireless devices 122, 124, 126 128 may be or include high power wireless devices or standard power wireless devices. The wireless devices 122, 124, 126, 128 ay further include home internet or HINT devices. Other types of communication platforms are possible.

Environment 100 may further include many components not specifically shown in FIG. 1 including processing nodes, controller nodes, routers, gateways, and physical and/or wireless data links for communicating signals among various network elements. Environment 100 may include one or more of a local area network, a wide area network, and an internetwork (including the Internet). Environment 100 may be capable of communicating signals and carrying data, for example, to support voice, push-to-talk, broadcast video, and data communications by end-user wireless devices 122, 124, 126, and 128. Environment 100 may include additional base stations, controller nodes, telephony switches, internet routers, network gateways, computer systems, communication links, or other type of communication equipment, and combinations thereof.

Other network elements may be present in environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between the access networks 170 and the core networks 102 and 202.

The methods, systems, devices, networks, access nodes, and equipment described herein may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes, including access nodes, controller nodes, and gateway nodes described herein.

The operations for mmWave assignment may be implemented as computer-readable instructions or methods, and processing nodes on the network for executing the instructions or methods. The processing node may include a processor included in the access node or a processor included in any controller node in the wireless network that is coupled to the access node.

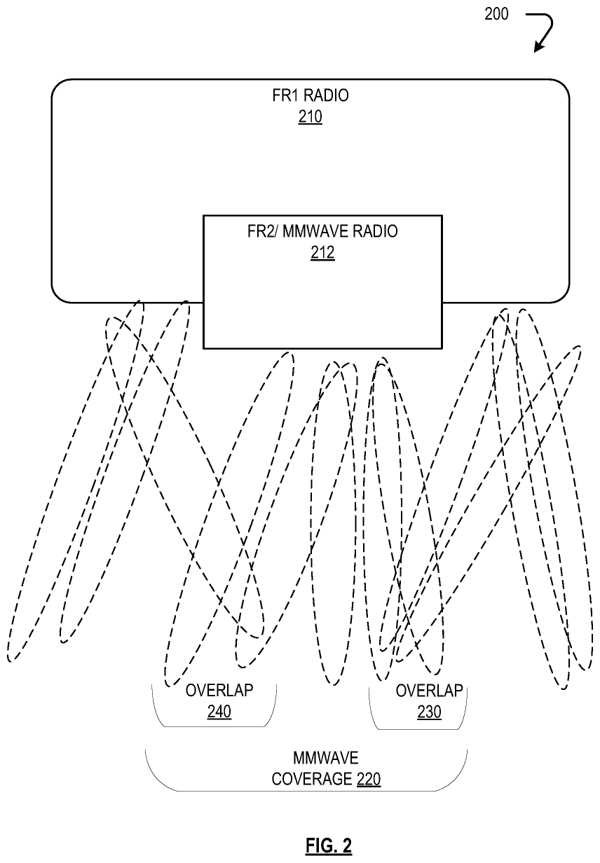

FIG. 2 depicts a further exemplary operating environment 200 for a mmWave assignment system 300 accordance with the disclosed embodiments. The operating environment may include a gNB, such as gNB 110, utilizing an FR1 radio 210 and a mmWave gNB, such as gNB 112, utilizing an FR2 mmWave radio 212. FR1 radio 210 and FR2 mmWave radio 212 utilize two different frequency ranges that are available for 5G RATs. The bands in frequency range 1, utilized by FR1 radio 210 carry much of the traditional cellular mobile communications traffic and may utilize some of the same frequency bands that were utilized for 4G LTE. Thus, the FR1 radio 210 may utilize for example, bands n41, n25, or n71.

The higher frequency bands in range FR2 utilized by mm Wave radio FR2 212 are aimed at providing a very high data rate capability at a short range. Mmwave transmissions are generally in a frequency range of 24-100 GHz. As illustrated, mm Wave beams encompass an area 220. The mmWave radio propagation of mm Wave radio FR2 212 is in every direction and sits inside of the FR1 coverage of FR1 radio 210. As illustrated, beams transmitted by the FR1 radio 210 overlap with the mm Wave radio beams in overlap areas 230 and 240.

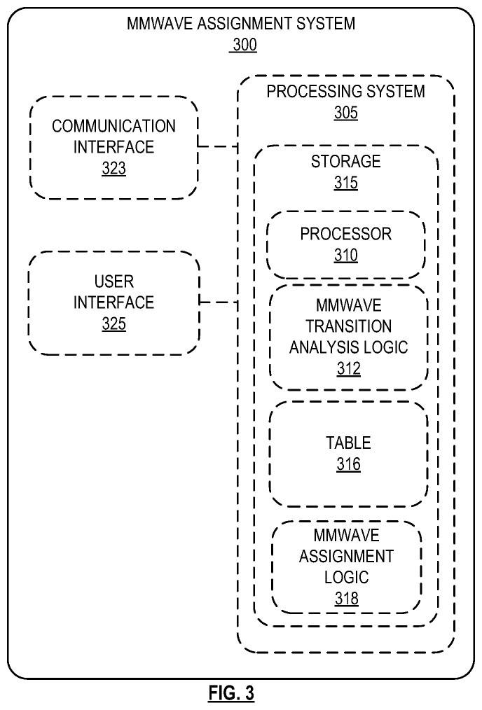

FIG. 3 depicts an exemplary mmWave assignment system 300, which may be configured to perform the methods and operations disclosed herein to trigger mm Wave coverage for eligible wireless devices, In the disclosed embodiments, the mm Wave assignment system 300 may be integrated with the access node 110, or may be an entirely separate component capable of communicating with the access nodes 110, core network 102 and/or the wireless devices 122, 124, 126, 128.

The mmWave assignment system 300 may be configured to transition eligible devices to mmWave coverage. To determine eligibility for mmWave coverage, the mmWave assignment system 300 may include a processing system 305. Processing system 305 may include a processor 310 and a storage device 315. Storage device 315 may include a disk drive, a flash drive, a memory, or other storage device configured to store data and/or computer readable instructions or codes (e.g., software). The computer executable instructions or codes may be accessed and executed by processor 310 to perform various methods disclosed herein. Software stored in storage device 315 may include computer programs, firmware, or other form of machine-readable instructions, including an operating system, utilities, drivers, network interfaces, applications, or other type of software. For example, software stored in storage device 315 may include one or more modules for performing various operations described herein. For example, instructions 312 may be provided to perform analysis of available mmWave coverage for each wireless device. The instructions or mmWave transition analysis logic 312 may be utilized to compare measurement reports from the wireless device with stored information correlating measurements with mmWave coverage. Further, instructions 318 may be provided to assign a wireless device to transfer a wireless device by handing it over to another access node, such as a long term evolution (LTE) eNodeB as a master node and to a 5G mmWave gNodeB as a secondary node. Processor 310 may be a microprocessor and may include hardware circuitry and/or embedded codes configured to retrieve and execute software stored in storage device 315.

The mm Wave assignment system 300 may include a communication interface 323 and a user interface 325. Communication interface 323 may be configured to enable the processing system 305 to communicate with other components, nodes, or devices in the wireless network. For example, the mmWave assignment system 300 can share intelligence with the access node 110.

Communication interface 323 may include hardware components, such as network communication ports, devices, routers, wires, antenna, transceivers, etc. User interface 325 may be configured to allow a user to provide input to the mm Wave assignment system 300 and receive data or information from the mmWave assignment system 300. User interface 325 may include hardware components, such as touch screens, buttons, displays, speakers, etc. The mmWave assignment system 300 may further include other components such as a power management unit, a control interface unit, etc.

The mmWave assignment system 300 thus may utilize the memory 315 and the processor 310 to perform multiple operations. For example, the processor 310 may access stored instructions in the memory 315 to locate a correlation between measurements reported by the wireless device and mmWave coverage. Further, a database or table 316 may be stored in memory that correlates measurements with mmWave coverage. For example, the table 316 may correlate FR1 beams with FR2 beams so that the processor 310 can determine which FR1 beams have significant overlap with FR2 beams and thus are in a location having a threshold strength of mmWave coverage required to execute steps to transition a wireless device to obtain mmWave coverage. In embodiments provided herein, the table 316 may be incorporated in the mmWave transition analysis logic 312.

The mmWave assignment system 300 may depend upon the network architecture. For example, in smaller networks, a single mmWave assignment system 300 may be disposed for communication with wireless devices and access nodes shown in FIGS. 1 and 2. However, in a larger network, multiple mmWave assignment systems 300 may be required to cover the network.

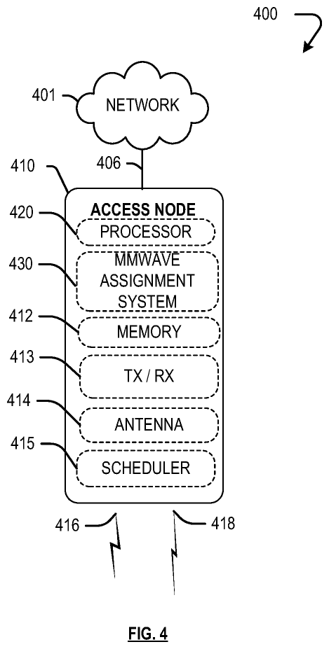

FIG. 4 illustrates an operating environment 400 for an exemplary access node 410 in accordance with the disclosed embodiments. In exemplary embodiments, the access node 410 is able to interact effectively with the mm Wave assignment system 300. The access node 410 can include, for example, a gNodeB having an FR1 radio 210. Access node 410 may comprise, for example, a macro-cell access node, such as access node 110, 112, 114 described with reference to FIG. 1.

Access node 410 is illustrated as comprising a processor 420, a mmWave assignment system 430, a memory 412, transceiver(s) 413, and antenna(s) 414. Processor 420 executes instructions stored on memory 412, while transceiver(s) 413 and antenna(s) 414 enable wireless communication with other network nodes, such as wireless devices and other nodes. For example, wireless devices may initiate uplink transmissions such that the transceivers 413 and antennas 414 receive messages including, for example, route information and performance parameters from the wireless devices, for example, over communication links 416 and 418. The transceivers 413 and antennas 414 may further pass the messages to a mobility entity in the core network. Further, the transceivers 413 and antennas 414 receive signals from the mobility entity such as a mobility management entity (MME) or access and mobility function (AMF) and pass the messages to the appropriate wireless device. Scheduler 415 may be provided for scheduling resources based on the presence and performance parameters of the wireless devices as well as based on policies transmitted from the core networks 102, 202. Network 401 may be similar to the network 101 discussed above with respect to FIG. 1.

In embodiments provided herein, processor 420 may operate in conjunction with scheduler 415 and mmWave assignment system 430 to make mmWave transmissions available to selected devices. In operation, the mmWave assignment system 430 may be integrated with the processor 420 or alternatively may comprise logic stored in the memory 412 to execute mmWave assignment procedures. For example, the mmWave assignment system 430 may generate instructions and may provide the received instructions to the wireless devices 122, 124, 126, 128.

While the processor 420, the mmWave assignment system 430, and the scheduler 415 are shown as separate components, these components may optionally be integrated in various combinations. For example, the processor 420 may perform the functions described above with respect to the mmWave assignment system 430 by accessing stored instructions from the memory 412. Further, the memory 412 may store service specific information, such as quality of service (QOS) requirements, timers, and thresholds. The stored thresholds may, for example, be default thresholds for sufficient mm Wave strength.

The access node 410 may utilize transceivers 413 and antennas 414 to communicate information, for example with the wireless devices 122, 124, 126, 128 and with the core networks 102 and 202. For example, these components may receive requests from the wireless devices 122, 124, 126, 128 and further may receive instructions, such as mmWave assignments the mmWave assignment system 430 or 300.

The methods, systems, devices, networks, access nodes, and equipment described herein may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes, including access nodes, controller nodes, and gateway nodes described herein.

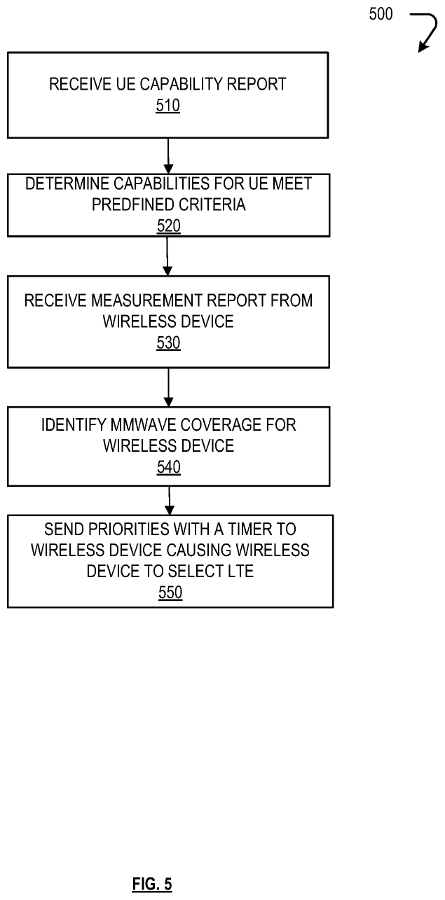

The disclosed methods for mmWave assignment are discussed further below. FIG. 5 illustrates an exemplary method 500 for mmWave assignment of wireless devices. Method 500 may be performed by any suitable processor discussed herein, for example, a processor 310 included in the mmWave assignment system 300. For discussion purposes, as an example, method 500 is described as being performed by the processor 310 of the mmWave assignment system 300.

Method 500 begins in step 510, when the mmWave assignment system 300 receives a UE capability report from a wireless device 122, 124, 126, 128. The UE capability report may include, for example, NRDC and ENDC capabilities.

Based on the UE capability report received in step 510, the mm Wave assignment system processor 310 determines that capabilities for the wireless device meet predefined criteria in step 520. Specifically, the mmWave assignment system processor 310 may determine that the wireless device is capable of receiving mmWave transmissions and is capable of EN-DC, but is not capable of NRDC.

In step 530, the mmWave assignment system processor 310 receives a measurement report from the wireless device 122, 124, 126, 128 in response to the CSI-RS transmitted by the access node 110. The measurement report may include for example, a signal strength report including for example, signal to interference and noise ratio (SINR) or reference signal received power (RSRP). Alternatively or additionally, the measurement report from the wireless device may include a report indicating received beams, such as, for example; synchronization signal block (SSB) beams, sounding reference signal (SRS) beams, or precoding matrix indicator (PMI) beams. For example, the wireless device may report receiving particular beams, such as PMI beams 7-12. In embodiments provided herein, the wireless devices may report both signal strengths and beam reception so that the mmWave assignment system 300 can combine measurements reports and beam reporting to assess mmWave coverage.

Upon receiving the measurement report, the mmWave assignment system processor 310 may identify mmWave coverage for the wireless device 122, 124, 126, 128. For example, the mmWave assignment system 300 may store correlations in the memory 315 or may access the correlations from another location. The stored correlations may be included, for example, with the mm Wave transition analysis logic 312. The stored information may correlate reported beams or reported signal strength with mmWave coverage. For example, the wireless device may report that it receives transmissions from PMI beams 7-12. The stored correlation logic 312 may identify these particular PMI beams as having significant overlap with mmWave beams from FR2 radio 212 and therefore determine that the wireless device is in an area having mmWave coverage of a threshold strength in step 540. Thus, the memory 315 may store threshold criteria for determining the sufficiency of mmWave coverage for the wireless device 122, 124, 126, 128.

Finally, in step 550, the mmWave assignment system processor 310 may set and send idle mode priorities with a timer to the wireless device 122, 124, 126, 128 causing the wireless device 122, 124, 126, 128 to select an LTE RAT in step 550. The selection of the LTE RAT in step 550 will cause the wireless device to be handed over from one core network 102 to another core network 202, which offers LTE as a master cell group (MCG). Further, the setting of idle mode priorities may trigger selection of LTE as a priority and mmWave as a secondary cell group (SCG). Accordingly, the wireless device may be transferred to utilize mm Wave with EN-DC.

The use of the timer determines how long a wireless device remains on mm Wave coverage. In embodiments provided herein, the mmWave assignment system 300 users LTE timer T320, which dictates that mmWave coverage is provided while the device is stationary until the timer expires. Once the wireless device 122, 124, 126, 128 becomes idle on the radio resource configuration (RRC) release, the processor 310 can thus send new idle mode priorities putting LTE as the top priority. Upon the next RRC release the processor 310 will send these dedicated idle mode priorities with the timer T320. These dedicated idle mode priorities will rearrange the idle reselection priorities, so the best LTE anchor bands are the top priority. The T320 timer will only apply the priorities for a certain time period while the wireless device 122, 124, 126, 128 is on the same cell ID. Upon moving to a different cell ID, the wireless device 122, 124, 126, 128 will read the new reselection priorities and use those moving forward. The T320 timer starts upon receipt or upon cell re-selection from another RAT such as that offered by the 5GSA gNB. At expiry of the T320 timer, the cell re-selection priorities are discarded.

Once idle, the wireless device 122, 124, 126, 128 will perform its S-criteria process to reselect LTE for its MCG. The wireless device will include measurement objects and corresponding events so that the wireless device will send measurement reports for the mmWave and mmWave will be added as the SCG. The T320 timer and priorities are refreshed upon each RRC release. The upon moving to a new cell or timer expiry, the dedicated priorities will be reset back to the default priority configuration.

Method 600 illustrates a particular embodiment of determining mmWave coverage. Method 600 may be performed by any suitable processor discussed herein, for example, a processor 310 included in the mmWave assignment system 300. For discussion purposes, as an example, method 600 is described as being performed by the processor 310 of the mmWave assignment system 300.

Method 600 begins in step 610, when the mmWave assignment system 300 stores information reflecting the overlap between FR2 beams and FR1 beams. Specifically, the mmWave assignment system 300 may store coverage areas of the radios FR1 and FR2 and the overlap of those coverage areas as illustrated and described with respect to FIG. 2.

In step 620 the mmWave assignment system 300 sends a channel state information reference signal (CSI-RS) to the wireless devices 122, 124, 126, 128. The CSI-RS is a reference signal that is used in the downlink (DL) direction in 5G NR, for the purpose of channel sounding and measuring the characteristics of a radio channel so that it can use correct modulation, code rate, beam forming etc.

After transmitting the CSI-RS, the mmWave assignment system 300 receives a response from the wireless device 122, 124, 126, 128 in step 630. The response from the wireless devices may include an indication of which FR1 beams the wireless device receives or a beam coverage indication. The FR1 beams may include, for example, SSB beams that cover relatively large areas and PMI based beams that are more focused and narrower. The FR1 beams may further include more focused SRS beams. The response from the wireless device 122, 124, 126, 128 to the CSI-RS includes CSI-RS feedback that can be used to more accurately pinpoint mm Wave coverage for the wireless device 122, 124, 126, 128. For example, the feedback may include PMI values that help the processor 310 to determine when the wireless device 122, 124, 126, 128 is in a location to best leverage the mmWave radio. Thus, while receiving FR1 beams, the wireless device 122, 124, 126, 128 may also report PMI values of the serving cell using the FR1 radio 210 in its CSI-RS feedback. From the PMI values, the processor 310 can accurately tell where the wireless device 122, 124, 126, 128 is located. As described further herein, the processor 310 can maintain a table associating the PMI values to the best coverage positions for mmWave. If the wireless device 122, 124, 126, 128 reports PMI values that indicate a good location, or a location have a threshold value for mmWave coverage, then the processor 310 will direct the wireless device 122, 124, 126, 128 to an eNB such as 112 for EN-DC mmWave coverage. Further, the wireless device response may include a strongest SSB beam and the processor 310 may store a table correlating SSB beams from the radio FR1 210 with the mmWave coverage. In embodiments provided herein, both the mm Wave gNB 112 and the eNB 114 may be co-located or disposed adjacent to the gNB 110 having the FR1 radio 210.

Based on the received information pertaining to the FR1 beams, the mmWave assignment system 300 may determine that the reported FR1 beams overlap sufficiently with FR2 beams from a nearby or co-located mmWave GnodeB. In this instance, the mmWave assignment system 300 determines that the wireless device is in an area having a threshold strength of mmWave coverage in step 640.

Finally, in step 650, based on the trigger of meeting a threshold of mmWave coverage, the mmWave assignment system 300 performs procedures to allow for mmWave coverage as described above.

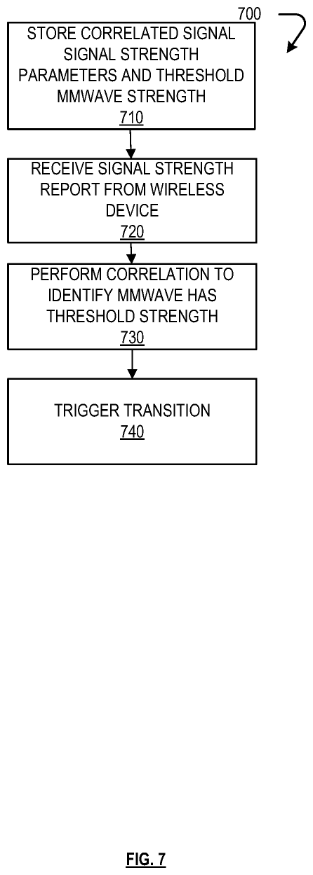

FIG. 7 illustrates an alternative method 700 that may be performed by the mmWave assignment system 300 in accordance with disclosed embodiments. Method 700 may be performed by any suitable processor discussed herein, for example, a processor 310 included in the mmWave assignment system 300.

Method 700 provides an alternative method that may be performed by the mmWave assignment system 300. Method 700 begins in step 710 by storing correlated signal strength parameters and a threshold mm Wave strength. For example, the processor 310 may store signal strength parameters in various locations within the coverage area of FR1 radio 210 and also signal strength parameters within the coverage area of mmWave FR2 radio 212. The signal strengths for FR1 radio 210 and mmWave FR2 radio 212 may be correlated in their overlapping coverage areas. The mmWave transition analysis logic 312 may be utilized to determine mmWave signal strength based on the received signal strength from the wireless device corresponding to the FR1 radio 210.

Thus, in step 720, the mmWave assignment system 300 receives a signal strength report from the wireless device 122, 124, 126, 128. The signal strength report may include, for example, RSRP or SINR measurements from the wireless device at its current location.

In step 730, in response to the signal strength report in step 720, the mmWave assignment system 300 performs a correlation to determine that the mm Wave strength for the reporting wireless device 122, 124, 126, 128 meets the stored threshold strength for mm Wave coverage. As described above, the mm Wave assignment system 300 may maintain a table correlating signal strength parameters from the FR1 radio 210 with mmWave coverage parameters from the FR2 radio 212.

Finally, in step 740, when the mmWave strength, determined based on the report from the wireless device and the stored correlations, meets the threshold strength, the mmWave assignment system 300 triggers a transition in step 740. For example, the mmWave assignment system 300 resets priorities for the wireless device and transmits the priorities with a timer to the wireless device 122, 124, 126, 128, after which the wireless device transitions to a neighboring or co-located eNodeb in order to transition the wireless device to LTE. Thus, the wireless device is able to utilize LTE and mm Wave coverage in EN-DC.

In embodiments set forth herein, signal strength parameters and beam reporting may be used in combination to determine the mmWave coverage strength for the wireless device. Accordingly, the processor 310 utilizes measurement reports that are setup in 5G SA. The processor 310 of the mmWave assignment system 300 can use a simple set of thresholds for each variable and if all thresholds are met, then the processor 310 concludes that the wireless device 122, 124, 126, 128 is within the mm Wave range of propagation. Through this process, the non-NRDC wireless device is able to leverage mmWave under optimal conditions.

In some embodiments, methods 500, 600, and 700 may include additional steps or operations. Furthermore, the methods may include steps shown in each of the other methods. As one of ordinary skill in the art would understand, the methods 500, 600, and 700 may be integrated in any useful manner and the steps may be performed in any useful sequence.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method comprising:
receiving a capability report and a measurement report from a wireless device;
determining based on the capability report that the wireless device supports millimeter wave (mmWave) coverage, but does not support new radio dual connectivity (NRDC);
determining, based on the measurement report, that the wireless device is in a location having a threshold strength of mmWave coverage; and
transitioning the wireless device to another access node to allow for the mm Wave coverage.

2. The method of claim 1, further comprising storing threshold criteria for determining that the wireless device is in a location having the threshold strength of mm Wave coverage.

3. The method of claim 1, further comprising receiving the capability report and the measurement report at a 5G standalone access node.

4. The method of claim 3, wherein transitioning the wireless device to another access node comprises handing the wireless device over to a long term evolution (LTE) eNodeB in a 5G non-standalone cell.

5. The method of claim 4, further comprising providing LTE as a main cell group (MCG) and mmWave as a secondary cell group (SCG).

6. The method of claim 1, further comprising triggering a handover of the wireless device from a 5G standalone access node to 5G non-standalone access node having mm Wave coverage.

7. The method of claim 1, wherein the measurement report comprises wireless device feedback for which synchronization signal block (SSB) beam is strongest.

8. The method of claim 7, further comprising comparing the wireless device feedback with a stored correlation of SSB beams with mm Wave coverage.

9. The method of claim 1, wherein the measurement report includes channel state information reference signal (CSI-RS) feedback reporting precoding matrix indicator (PMI) values.

10. The method of claim 9, further comprising comparing the received PMI values to stored information correlating PMI values with mm Wave coverage.

11. A system comprising:
a communication interface receiving a capability report and a measurement report from a wireless device;
a processor accessing stored instructions to perform operations including:
determining based on the capability report that the wireless device supports millimeter wave (mmWave), but does not support new radio dual connectivity (NRDC);
determining, based on the measurement report, that the wireless device is in a location having strong mmWave coverage; and
transitioning the wireless device to allow for mm Wave coverage based on the determinations.

12. The system of claim 11, further comprising a memory storing threshold criteria for determining that the wireless device should receive mm Wave coverage.

13. The system of claim 12, the operations further comprising comparing the measurement report with the stored threshold criteria.

14. The system of claim 11, the communication interface receiving the capability report and the measurement report at a 5G standalone access node.

15. The system of claim 11, the operations further comprising assigning the wireless device to mmWave coverage by handing the wireless device over to a long term evolution (LTE) eNodeB in a 5G non-standalone cell providing evolved-universal terrestrial radio access-new radio dual connectivity (EN-DC) with long term evolution (LTE).

16. The system of claim 15, the operations further comprising assigning the wireless device to LTE as a main cell group (MCG) and mmWave as a secondary cell group (SCG).

17. The system of claim 11, the operations further comprising triggering a handover of the wireless device from a 5G standalone access node to 5G non-standalone access node capable of assigning mm Wave coverage to the wireless device.

18. The system of claim 11, wherein the measurement report comprises a beam coverage indication for the wireless device.

19. A non-transitory computer-readable medium storing instructions executed by a processor to perform operations comprising:
receiving a capability report from a wireless device indicating that the wireless device supports millimeter wave (mmWave), but does not support new radio dual connectivity (NRDC);
receiving a measurement report from the wireless device;
accessing stored threshold criteria for indicating the wireless device should receive mm Wave coverage;
comparing the measurement report with the stored threshold criteria to determine that the measurement report meets the stored threshold criteria; and
assigning the wireless device to a 5G non-standalone cell capable of assigning mm Wave coverage to the wireless device.

20. The non-transitory computer readable medium of claim 19, wherein the measurement report includes channel state information reference signal (CSI-RS) feedback reporting precoding matrix indicator (PMI) values and the operations include comparing the received PMI values to stored information correlating PMI values with mmWave coverage.
